(19) United States
(12) Patent Application Publication
(10) Pub. No.: US 2011/0157639 A1
(43) Pub. Date: Jun. 30, 2011

(54) IMAGE PROCESSING SYSTEM, METHOD, AND PROGRAM RECORDING MEDIUM

(75) Inventor: Mizuki Hayakawa, Kawasaki-shi (JP)

(73) Assignee: CANON KABUSHIKI KAISHA, Tokyo (JP)

(21) Appl. No.: 12/971,475

(22) Filed: Dec. 17, 2010

(30) Foreign Application Priority Data
Dec. 24, 2009 (JP) 2009-292836

(51) Int. Cl. H04N 1/41; G06F 3/12

(52) U.S. Cl. 358/1.15; 358/426.01

(57) ABSTRACT

An image processing system to transmit original image data read by an image reading device to an image processing apparatus. The image reading device reads the original image data, performs a variable-length compression operation on the original image data for each block, and transmits compressed data to the image processing apparatus for each unit quantity. The image processing apparatus acquires the original image data size, obtains the total number of the blocks included in the original image data based on the original image data size, and receives the compressed data. The image processing apparatus additionally performs a decompression operation on the received data, obtains the number of the blocks included in the decompressed image data, and displays a receiving progress state from a relationship between the total number of the blocks included in the original image data and the number of received blocks included in the received data.

### BACKGROUND OF THE INVENTION

1. Field of the Invention

The present invention relates to an image processing system for reading an original placed on an image reading device and transferring the read image to an image processing apparatus.

2. Description of the Related Art

Conventionally, as a method for reading an original placed on an image reading device, a method has been used in which settings (hereinafter, reading settings) such as a reading area, a reading resolution, a reading mode (color reading, gray scale reading, and black and white reading) and the like are transmitted from an image processing apparatus to the image reading device and image data read from the image reading device is received by the image processing apparatus.

A method has been used in which the image reading device sequentially transmits images read from each line and the image processing apparatus sequentially receives the images. However, when a communication speed of an interface used for communication between the image reading device and the image processing apparatus is slow, there is a problem that the image processing apparatus takes time to receive the image data. Communication speed of an interface that uses wireless communication is not as stable as wired communication, so that the communication speed may slow down. The reading speed of the image reading device may faster than a communication speed. In such a case, it is necessary that the image reading device includes a memory to store image data of the reading area or the image reading device stops reading the image when a memory shortage occurs.

A method for compressing and transferring image data to solve a problem of reading time that depends on a communication speed of an interface is described in Japanese Patent Laid-Open No. 07-200849. As an image data compressing method, the JPEG coding method is generally used. Further, the JPEG compression is a method in which an image is divided into block units and compressed, so that the image processing apparatus can receive image data each time the image data is compressed, and thus it is possible to perform sequential transmission.

However, when the data is JPEG-compressed and transferred sequentially, before the reading is completed, it is impossible to know the total amount of compressed image data in advance because the compression method is a variable-length compression method. Then, it is impossible to compare the received data to the total amount of compressed image data. Therefore, the present invention displays a receiving state in an image processing apparatus that receives read data which is variable-length compressed and transferred.

### SUMMARY OF THE INVENTION

An image processing system according to the present invention is a system, in which an original image data read by an image reading device is transmitted to an image processing apparatus, comprising: the image reading device which reads the original image data according to a reading condition and includes a reading unit for reading the original image data, a compression unit for performing a variable-length compression operation on the original image data for each block, and a first transmitting unit for transmitting compressed data compressed by the compression unit to the image processing apparatus for each unit quantity; and the image processing apparatus which includes an acquisition unit for acquiring the size of the original image data, a first calculator for obtaining the total number of the blocks included in the original image data from the size of the original image data, a first receiving unit for receiving the compressed data transmitted by the first transmitting unit, a decompression unit for performing a decompression operation on the received data received by the first receiving unit, a second calculator for obtaining the number of the blocks included in the decompressed image data decompressed by the decompression unit, and a display unit for displaying a progress state of receiving in the first receiving unit from a relationship between the total number of the blocks included in the original image data and the number of received blocks included in the received data that has already been received by the first receiving unit.

Further features of the present invention will become apparent from the following description of exemplary embodiments with reference to the attached drawings.

### BRIEF DESCRIPTION OF THE DRAWINGS

FIG. 1 is a diagram showing a hardware configuration of an image reading device according to a first exemplary embodiment.

FIG. 2 is an external view of the image reading device according to the first exemplary embodiment.

FIG. 3 is a flowchart for reading an image by the image reading device in the first exemplary embodiment.

FIG. 4 is a flowchart for receiving image data by an image processing apparatus in the first exemplary embodiment.

FIG. 5 is a flowchart for performing variable-length compression in the first exemplary embodiment.

FIG. 6 is tables for explaining the variable-length compression in the first exemplary embodiment.

FIG. 7 is a flowchart for performing block decompression in the first exemplary embodiment.

FIG. 8 is a display example showing a user a progress state of reception in the first exemplary embodiment.

FIG. 9 is a flowchart for receiving image data by an image processing apparatus in a second embodiment.

FIG. 10 is a flowchart for receiving image data by an image processing apparatus in a third embodiment.

FIG. 11 is graphs for explaining a progress state that is estimated and displayed.

### DESCRIPTION OF THE EMBODIMENTS

### First Exemplary Embodiment

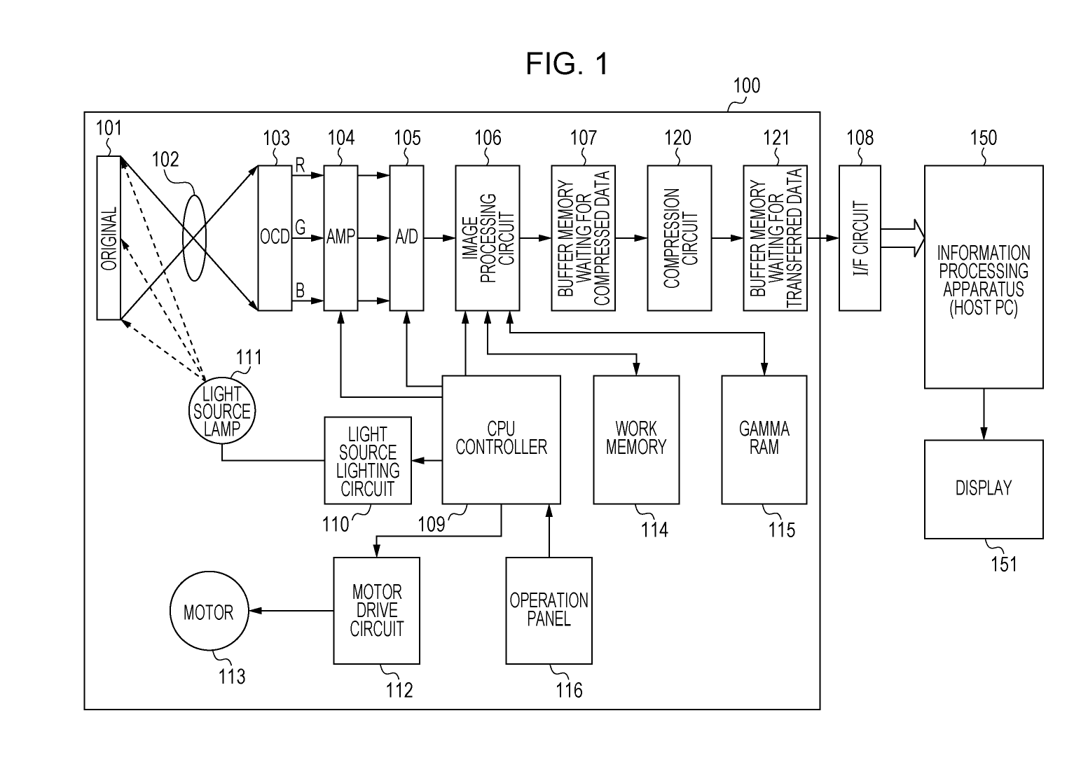

An image processing system including an image reading device and an image processing apparatus according to this embodiment will be described with reference to a block diagram in FIG. 1.

Reference numeral 100 denotes an image reading device, and reference numeral 101 denotes an original to be read. A light source lamp 111 illuminates the original 101, and reflected light having an intensity commensurate with the density of the surface of the original forms an image on a line image sensor 103, which is a solid-state image sensing element such as a CCD sensor, through an image forming lens 102. Reference numeral 110 denotes a light source lighting circuit for lighting the light source lamp (111). Reference numeral 104 denotes an amplifier for amplifying an analog image signal output from the line image sensor (103). Reference numeral 112 denotes a motor drive circuit for driving an optical system drive motor (113) such as a stepper motor. The motor drive circuit (112) outputs an excitation signal of the drive motor (113) by a control signal from a CPU controller (109) which is a system control device of the image reading device (100). Reference numeral 105 denotes an A/D converter, which converts an analog image signal outputted from the amplifier (104) into a digital image signal. Reference numeral 106 denotes an image processing circuit, which performs image processing such as offset correction, shading correction, digital gain adjustment, color balance adjustment, color masking conversion, and resolution conversion in main and sub scanning directions on the digitalized image signal. Reference numeral 107 denotes a buffer memory including a RAM, and the buffer memory (107) temporarily stores data after the image processing. Reference numeral 120 denotes a compression circuit, which compresses image data stored in the buffer memory (107). Reference numeral 121 denotes a buffer memory including a RAM, and the buffer memory (121) temporarily stores data after the compression. Reference numeral 108 denotes an interface circuit, which transmits and receives commands and images to and from an image processing apparatus (150). For the interface circuit (108), an interface such as SCSI, parallel, USB, IEEE1394, LAN, or wireless LAN is used. Reference numeral 114 denotes a work memory which is used as a temporary work memory when the image processing circuit performs image processing. Reference numeral 115 denotes a gamma LUT for storing a density gamma conversion LUT and performing gamma correction. Reference numeral 109 denotes a CPU controller that controls the image reading device (100) in accordance with commands from the image processing apparatus (150). The CPU controller (109) controls the motor drive circuit (112), the light source lighting circuit (110), the image processing circuit (106), and the like. A state in which a switch included in an operation panel (116) is pressed is detected by the CPU controller and transmitted to the image processing apparatus (150) via an interface (a first transmitting unit, a first receiving unit, a second transmitting unit, and a second receiving unit). The image processing apparatus (150) is a host computer such as a personal computer, and connected a monitor display (151). Although this embodiment includes a three-line CCD sensor (103) that reads RGB three colors and a white light source (111), the same function can be realized by a CIS that includes a single-color one-line image sensor and light sources of RGB three colors which are selectively lighted.

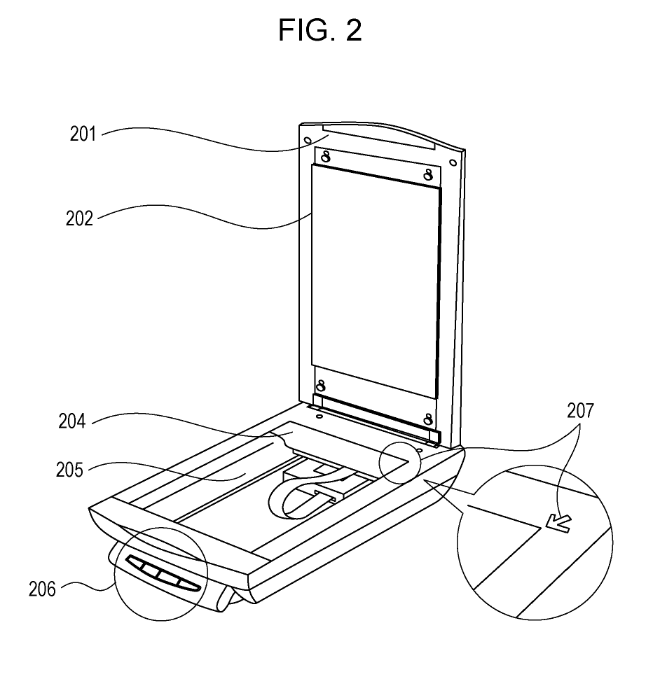

FIG. 2 shows an example of an external view of the image reading device according to this embodiment. Reference numeral 201 denotes a document pressing plate for stably pressing an original on a platen, reference numeral 202 denotes a white sheet for tightly attaching a thin sheet original to the platen and whitening margins of the original, and reference numeral 204 denotes a reading optical system unit. Reference numeral 205 denotes the platen, which holds the original while holding a reading surface of the original on a flat surface. Reference numeral 206 denotes an operation panel which is used to send a simple instruction such as a start of reading to the information processing apparatus (150) which is an image data transmission destination. Reference numeral 207 denotes a mark indicating the datum point of the original which indicates the reading start position of the original placed on the platen.

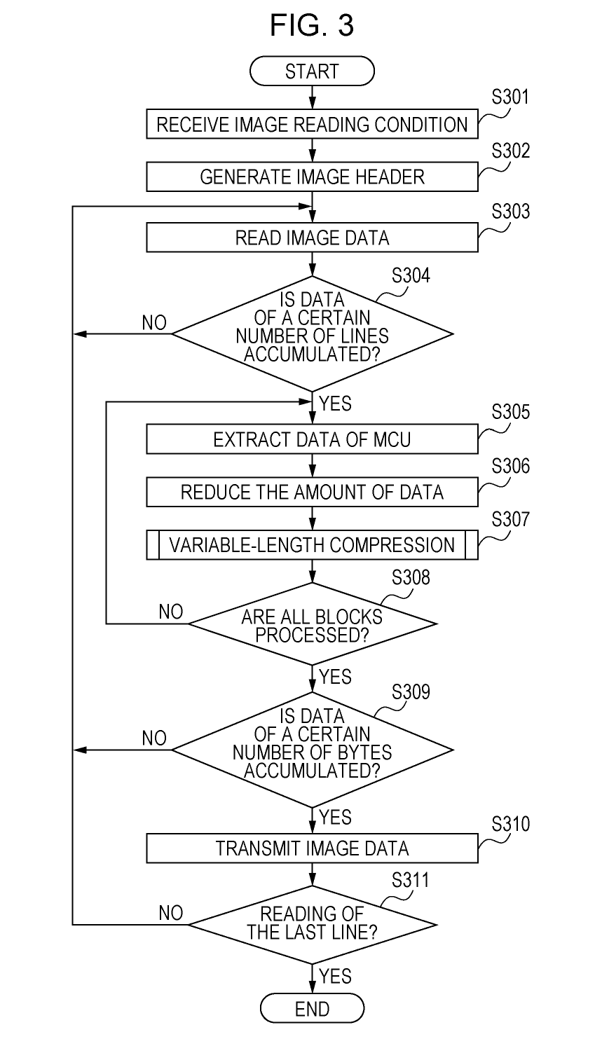

FIG. 3 is a flowchart describing an operation performed by the image reading device (100) in the first exemplary embodiment. In step S301, the image reading device (100) receives reading conditions to read an original from the image processing apparatus (150). As main reading conditions, there are the position, width, and height of the image to be read, a reading mode indicating that the image is read in color, gray, or black and white, the resolution of reading, a compression rate when compressing and transmitting the image, and other specifications of image processing performed by the image reading device. In step S302, the image reading device (100) generates an image header necessary to decompress image data which is compressed and transferred to the image processing apparatus. The image header is defined on the basis of an image format standard. A table necessary for decompressing the image data, and the width, height, and bit depth of the image data are recorded in the image header.

In step S303, the image reading device (100) reads image data. The image reading device (100) drives the line image sensor (103) on the basis of the specified reading mode and the resolution of reading, and operates the drive motor (113) according to the resolution of reading. The read data is stored in the buffer memory (107) waiting for compressed data. In step S304, the image reading device (100) determines whether or not a certain number of lines are accumulated. In the JPEG compression, an image is divided into 8×8 unit blocks (hereinafter referred to as MCU: Minimum Coded Unit) and compression is performed on each block, so that an image can be compressed when at least 8 lines are accumulated. If at least 8 lines are accumulated, the process proceeds to step S306. If at least 8 lines are not accumulated, the process proceeds to step S303 and image data is read.

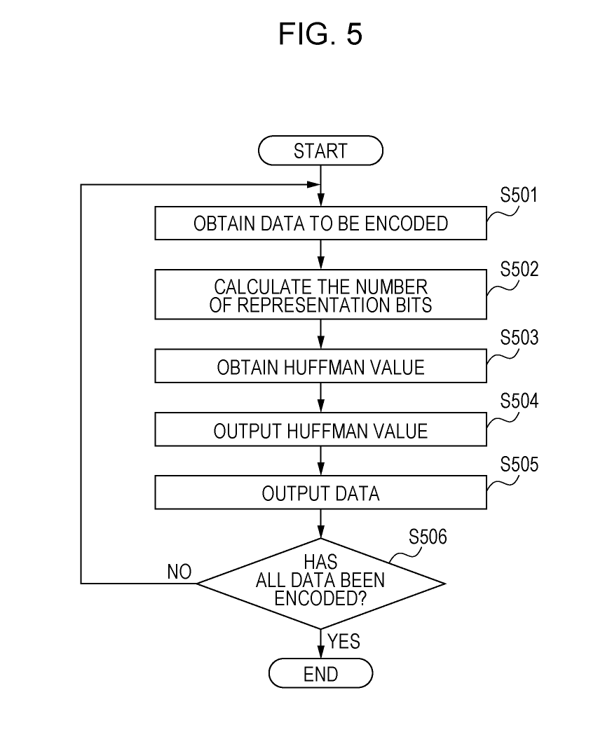

In step S305, data of one MCU (8×8 pixels) is extracted from the buffer memory (107) waiting for compressed data. In step S306, the amount of data is reduced. In the JPEG compression, a discrete cosine transform (DCT) is performed, and different quantization is performed on each frequency. In step S307, the variable-length compression is performed. The details will be described in FIG. 5. The variable-length compressed data is outputted in bit units instead of bytes unit, and accumulated in the buffer memory (121) waiting for transmitted data.

In step S308, the image reading device (100) checks whether the image data in which a certain number of lines are accumulated is variable-length compressed or not. For example, when an image having a width of 100 pixels is divided into 8×8 block units and compressed, the image is divided into 13 MCUs because 100/8=12.5, which is rounded up to 13. If all of the 13 MCUs are variable-length compressed, the process proceeds to step S309. If there is data that is not variable-length compressed, the process proceeds to step S305. In step S309, the image reading device (100) determines whether or not a certain number of bytes of data that are not yet transmitted are accumulated. Here, the image reading device (100) transmits and receives information of 1024 bytes at a time to and from the image processing apparatus (150), so that the image reading device (100) determines whether or not data of 1024 bytes is accumulated.

In step S310, the image data is transferred to the image processing apparatus (150). The image processing apparatus (150) transmits the reading condition to read an original in step S301, and then performs processing for reading image data from the image reading device (100). Here, if a certain amount (1024 bytes) of data being transmitted and received can be transferred, the image processing apparatus (150) reads the image. Here, if the certain amount (1024 bytes) of data is not accumulated, the image processing apparatus (150) waits until the data can be read.

In step S311, if the last line has been read, the process ends. If the last line has not yet been read, the process proceeds to step S303, and the image processing apparatus (150) reads the image data again.

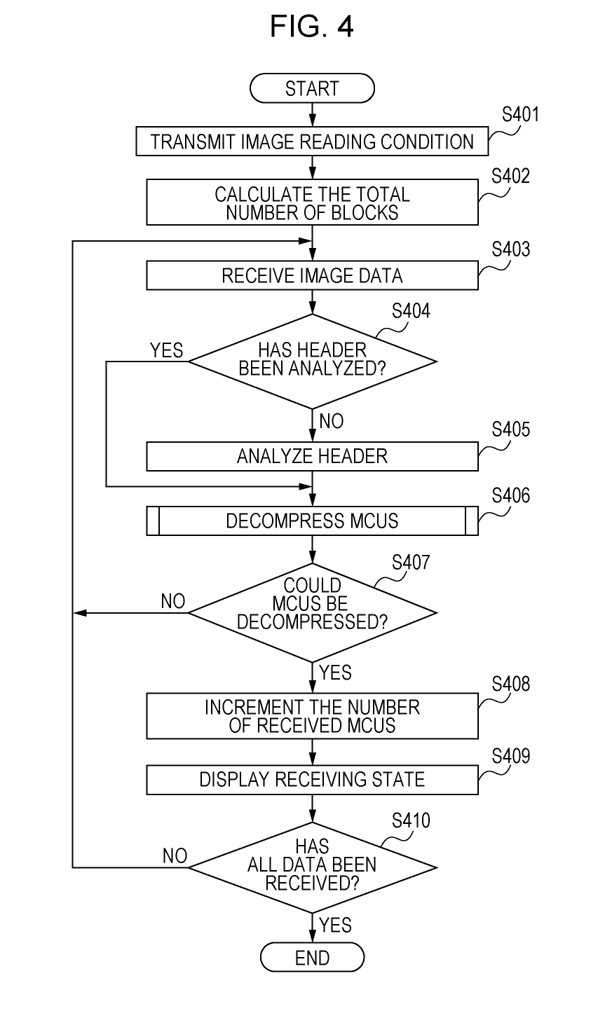

FIG. 4 is a flowchart describing an operation in which the image processing apparatus (150) receives image data read by the image reading device (100) in the first exemplary embodiment. In step S401, the image processing apparatus (150) transmits a reading condition to read an original to the image reading device (100). This reading condition corresponds to the reading condition received in step S301 in FIG. 3. In step S402, the image processing apparatus (150) obtains the total number of MCUs, which is the total number of blocks, from the reading condition (a first calculation unit). When the image is divided into MCUs of 8×8 pixels and compressed, the number of MCUs in the height direction is obtained by the height/8 (rounded up), and the number of MCUs in the width direction is obtained by the width/8 (rounded up). The total number of MCUs can be obtained by multiplying the number of MCUs in the height direction and the number of MCUs in the width direction together.

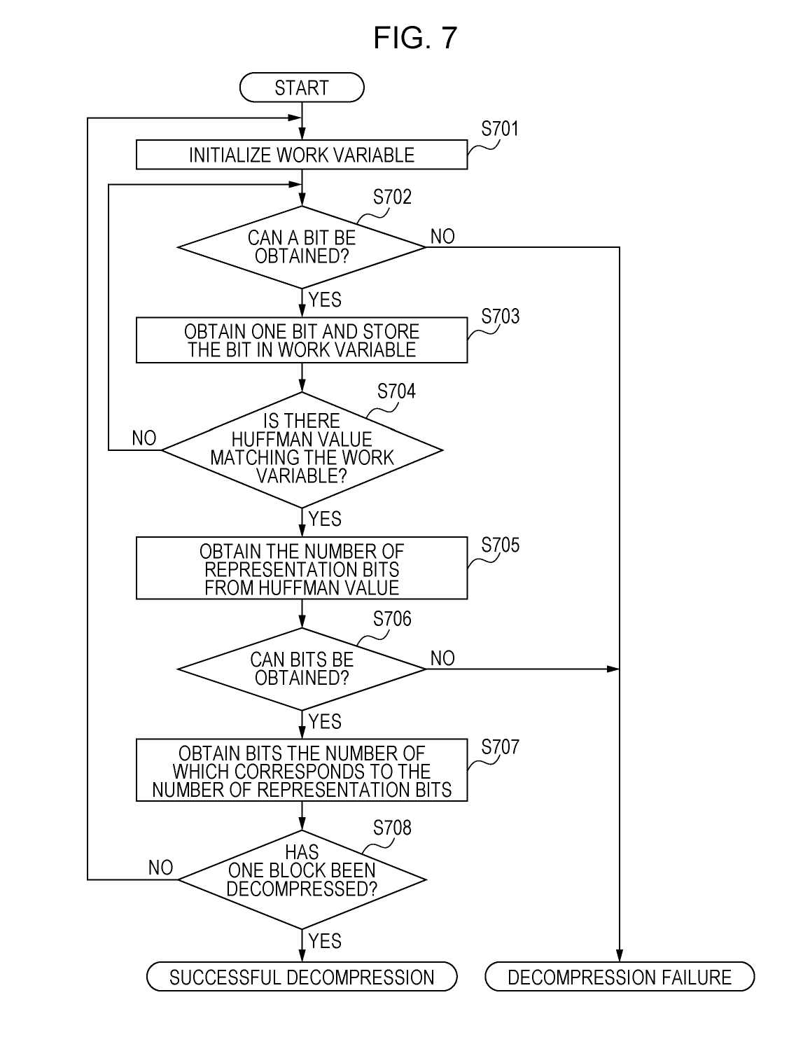

In step S403, the image processing apparatus (150) receives the image data from the image reading device. This image data is received corresponding to the data transmitted in step S310 in FIG. 3. In step S404, if an image header has not been analyzed from the received image data, the process proceeds to step S405. If the image header has already been analyzed, the process proceeds to step S406. In step S405, the image processing apparatus (150) analyzes the image header of the received data. As described in step S302 in FIG. 3, the image header information is defined on the basis of an image format standard, so that the image processing apparatus (150) analyzes the image header on the basis of the standard. By the analysis, the image processing apparatus (150) obtains the position from which the compressed image data starts. In JPEG data, specified data indicating the start of the image data is described in the last portion of the image header, so that the image processing apparatus (150) finds the specified data. Further, the image processing apparatus (150) obtains a table for decompressing the variable-length compressed data. In step S406, the image processing apparatus (150) decompresses each MCU of the received imaged data. The details of the decompression will be described in a flowchart in FIG. 7. In step S407, the image processing apparatus (150) checks whether or not all MCUs of the image data could be decompressed in step S406. The image processing apparatus (150) receives a certain number of bytes of image data one by one, so that one MCU may be separately included in one received data and the next received data. In this case, when the image processing apparatus (150) receives certain data and decompresses each MCU of the data, data shortage occurs when the image processing apparatus (150) tries to decompress the last portion of the data, so that the decompression fails. In this case, the process proceeds to step S403. After receiving the next data, the image processing apparatus (150) decompresses each MCU of the data. When the data is broken down, the data cannot be decompressed. However the exception processing in this case is omitted in this flowchart.

In step S408, the number of received MCUs is incremented (a second calculation unit). In step S409, the image processing apparatus (150) displays a receiving state from the total number of MCUs obtained in step S402 and the number of received MCUs. When displaying the receiving state in number, the receiving state can be displayed in percentage obtained by a calculation of 100×the number of received MCUs/the total number of MCUs. On the other hand, the receiving state can be displayed with a progress bar. In step S410, when the image processing apparatus (150) determines that all the data has been received, the process ends.

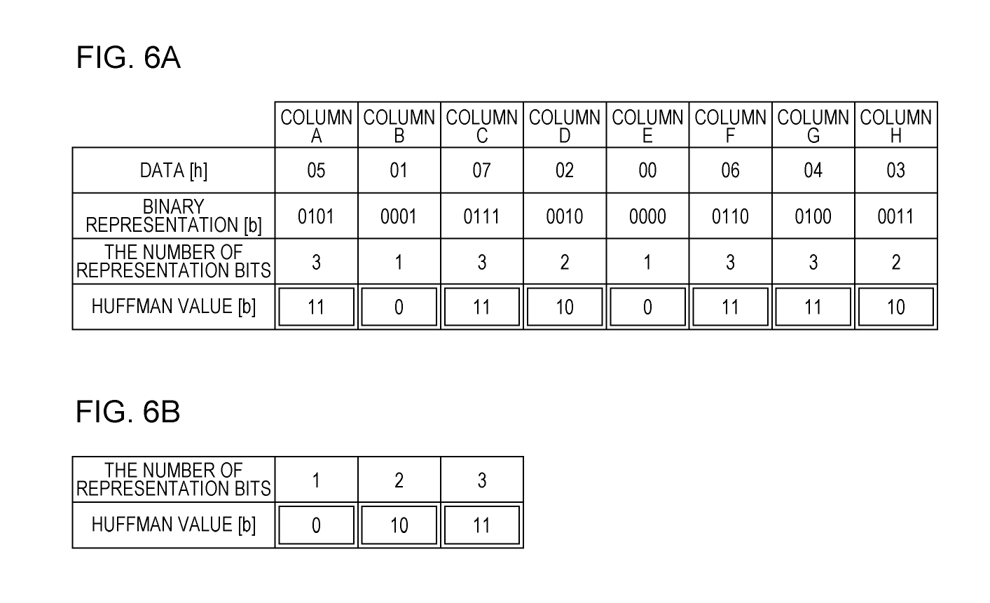

The variable-length compression will be described with reference to a flowchart in FIG. 5 and a table in FIG. 6. This processing corresponds to step S307 in FIG. 3. Although, in JPEG compression, a compression rate is increased by variable-length compressing a DC component and an AC component separated from data after DCT, it is not an essential part of this proposed patent, so that only the variable-length compression will be described without separating the data for simplicity of description. As a specific example, data to be compressed are defined to be 05 h, 01 h, 07 h, 02 h, 00 h, 06 h, 04 h, and 03 h, and described in the second row in FIG. 6A. FIG. 6B indicates the Huffman table necessary for the compression.

In step S501, one byte is obtained from the data to be encoded. First, 05 h is extracted. In step S502, representation bits are calculated. When representing 05 h in binary, the value is 00000101b, so that 05 h can be represented as 101b using three bits. Thus, the representation bits are three. In step S503, a Huffman value is obtained. A value corresponding to the number of representation bits is obtained from FIG. 6B. When the number of the representation bits is three, the Huffman value is 11. The processing so far is described in the A column in FIG. 6A. In step S504, the obtained Huffman value is outputted without change. In this example, the value 11 is outputted without change. In step S505, data corresponding to the number of the representation bits is outputted. In this example, 05 h is 101b when the number of representation bits is three, so that 101 is outputted. The data compressed so far is 11 101.

In step S506, it is determined whether or not all the data is encoded. The first byte of the 05 h, 01 h, 07 h, 02 h, 00 h, 06 h, 04 h, 03 h is compressed into 11 101, and the second and the following bytes are also compressed in the same manner as in the first byte. The result of the compressing is 110 101 0 1 110 111 10 10 0 0 110 110 110 100 10 11, and when describing in a unit of 8 bits, the result is 11010101 11011110 10001101 10110100 1011. The more the number of data having a smaller number of bits of Huffman value, the higher the compression rate is. Since the number of bits of a Huffman value of inputted data varies, the bit length of the compressed data is variable depending on the inputted data.

A method for decompressing variable-length compressed MCU data will be described with reference to a flowchart of FIG. 7. This processing corresponds to step S406 in FIG. 4. In step S701, a work variable is initialized to 0. In step S702, it is checked whether or not one bit can be obtained from read data. While data is being decompressed, if all the data read from the image reading device has been obtained, there is no data to be decompressed, so that one bit cannot be obtained and the decompression fails. In step S703, one bit is obtained and stored in the work variable. At this time, if data has already been stored in the work variable, the data is shifted left by one bit and new bit is stored in the least significant bit. In step S704, it is checked whether or not there is a Huffman value that corresponds to the work variable. In the Huffman table shown in FIG. 6B, when the work variable is 0, the Huffman value is 0, and thus the process proceeds to step S705. When the work variable is 1, there is no Huffman value, so that a bit is obtained again, and when the work variable becomes 10 or 11, there is a Huffman value, and thus the process proceeds to step S705. In step S705, the number of representation bits is obtained from the Huffman value. In step S706, in the same manner as in step S702, it is checked whether or not bits can be obtained. The number of bits that can be obtained which is checked here is the number of representation bits which is obtained in step S705.

In step S707, bits, the number of which is the number of the representation bits, are outputted. Although, when the image data is decompressed, the image is formed on the basis of the obtained bits, when a progress bar is displayed, the processing is only to obtain bits. In step S304, it is checked whether or not an MCU is decompressed. When data corresponding to an MCU is obtained, one MCU can be successfully decompressed. When data corresponding to an MCU is not obtained, the process proceeds to step S702 again.

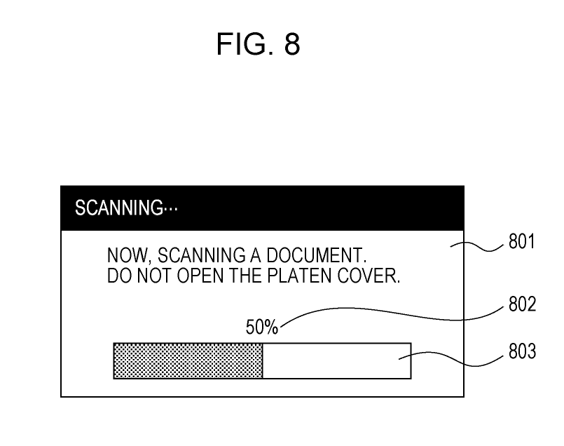

FIG. 8 shows an example of a progress state shown to a user by the image processing apparatus. Reference numeral 801 denotes a message dialog, and the message dialog is displayed on the display (151) connected to the image processing apparatus. Reference numeral 801 denotes a text displayed on the message dialog (801), and the text shows the progress state in percentage. Reference numeral 803 denotes a progress bar displayed on the message dialog (801), and the progress bar graphically displays the progress state.

By the operation described above, in a system in which image data is variable-length compressed in a scanner and sequentially transferred to the image processing apparatus, it is possible to show the progress state of receiving data to a user by using the total number of MCUs obtained by the image processing apparatus in advance and the number of variable-length compressed MCUs that have been decompressed by the image processing apparatus.

### Second Exemplary Embodiment

Although, in the first exemplary embodiment, the total number of MCUs is obtained from the reading condition transmitted from the image processing apparatus to the image reading device, there is a case in which the width and the height of the image are not known by the image processing apparatus. For example, there is a case in which a range to be read is determined in the image reading device and the image is transmitted to the image processing apparatus. In the second exemplary embodiment, a method for displaying the progress state of the reading even in such a case by obtaining the total number of MCUs from the header of the image data transmitted to the image processing apparatus. The difference from the first exemplary embodiment is only an operation when the image processing apparatus (150) receives image data read by the image reading device (100), and the operation is shown by a flowchart modified from the flowchart of FIG. 4 in the first exemplary embodiment. In this exemplary embodiment, only the difference will be described.

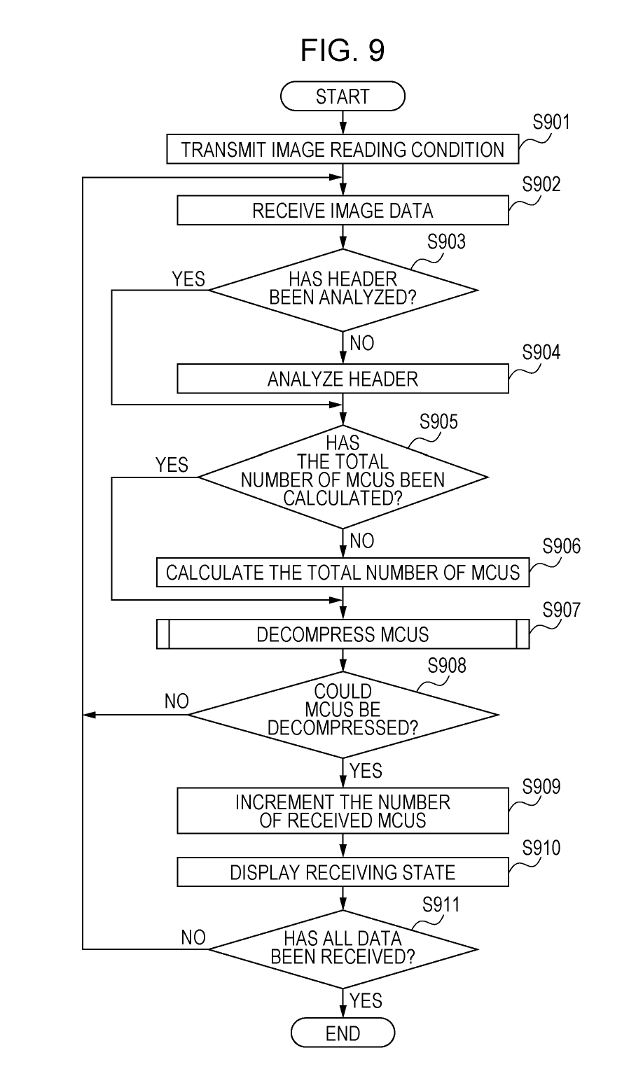

FIG. 9 is a flowchart describing an operation in which the image processing apparatus (150) receives image data read by the image reading device (100) in the second exemplary embodiment. In step S901, the image processing apparatus (150) transmits a reading condition to read an original to the image reading device (100). This reading condition corresponds to the reading condition received in step S301 in FIG. 3. In step S903, the image processing apparatus (150) receives the image data from the image reading device. This operation corresponds to the data transmission in step S310 in FIG. 3. In step S903, if the image header has not been analyzed from the received data, the process moves to step S905. If the image header has already been analyzed, the process proceeds to step S906.

In step S904, the image processing apparatus (150) analyzes the image header information of the received data. In addition to the same processing as that in step S405 in FIG. 4, the width and the height of the received image data are obtained. In step S905, if the total number of data blocks has not been calculated, the process proceeds to step S906, and if the total number of data blocks has been calculated, the process moves to step S907. In step S906, the total number of MCUs is obtained from the width and the height of the image. At this time, the width and the height of the image are obtained from the header information analyzed in step S904. The obtaining method is the same as that in step S402. The operation from step S907 to step S911 is the same as that from step S406 to step S410.

By the operation described above, in a system in which image data is variable-length compressed in a scanner and sequentially transferred to the image processing apparatus, even when the width and the height of the image is determined in the image reading device, it is possible to show the progress state of receiving data to a user by obtaining the total number of MCUs from the image header information and decompressing and counting the variable-length compressed MCUs in the image processing apparatus.

### Third Exemplary Embodiment

In the first exemplary embodiment, in step S403 in FIG. 4, it may take time to receive the image data read by the image reading device. In the third exemplary embodiment, a method for displaying the progress state even when it takes time to receive the image data will be described. The difference from the first exemplary embodiment is only an operation when the image processing apparatus (150) receives the image data read by the image reading device (100), and the operation corresponds to the flowchart of FIG. 4 in the first exemplary embodiment and the description of the flowchart. In this exemplary embodiment, only the difference will be described.

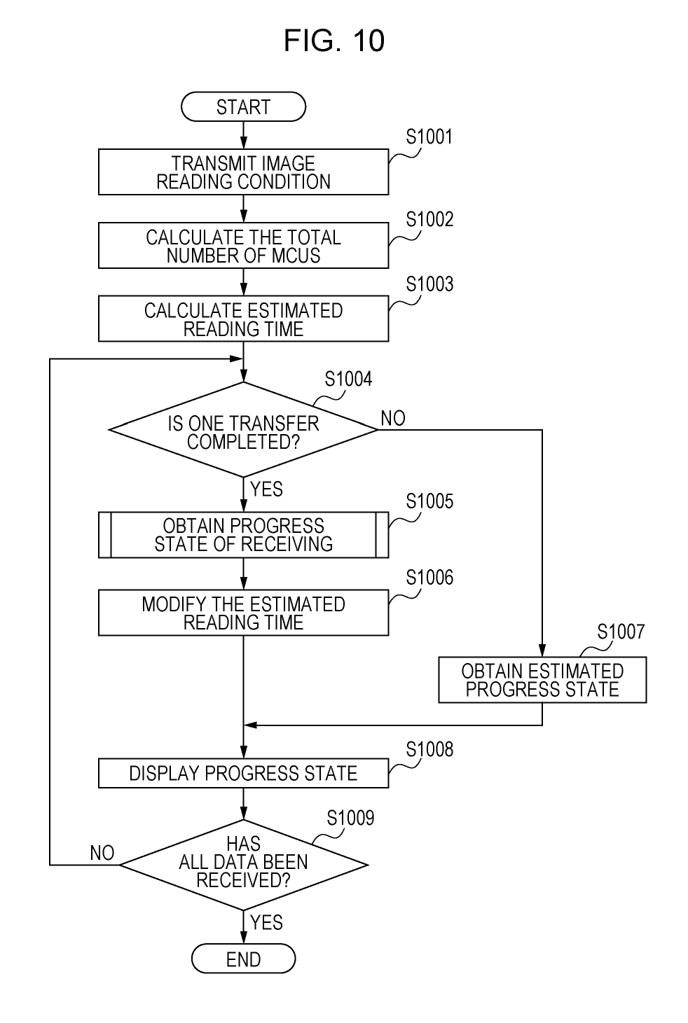

FIG. 10 is a flowchart describing an operation in which the image processing apparatus (150) receives image data read by the image reading device (100) in the third exemplary embodiment. The operation of steps S1001 and S1002 is the same as that of steps S401 and S402 in FIG. 4. In step S1003, an estimated time for the image processing apparatus to read the image is calculated. The image reading device (100) reads the image by driving a drive motor (113) at a constant speed. The speed for driving the drive motor (113) is inversely proportional to the reading mode and the reading resolution, and determined in advance as design values. The time for the drive motor (113) to be derived is obtained from the speed of driving the motor and the length of the image to be read. Although the image reading device takes time to perform image processing, compression processing, and communication with the image processing apparatus (150) in addition to driving the motor, the motor driving time is used as an approximate estimated time. In step S1004, it is determined whether the image data is being received from the image reading device. If one data transfer, which is performed to transfer 1024 bytes of data that is a predetermined amount of information to be transferred at one time, is completed, the process proceeds to step S1005, and if the one data transfer is not completed, the process proceeds to step S1007. In step S1005, the progress state of receiving is obtained. This processing corresponds to the processing of steps S404 to S409 in FIG. 4. In this processing, the number of blocks to be received is obtained. In step S1006, the estimated reading time is modified using the obtained receiving state. Assuming that there is a proportional relationship between the estimated time and the number of blocks, an estimated reading time modified by (modified estimated reading time=elapsed time×the total number of blocks/the number of received blocks) is obtained. In step S1007, an estimated progress state of receiving is obtained. This is obtained by elapsed time/estimated reading time. In step S1008, the receiving state obtained in step S1005 or step S1007 is displayed. In step S1009, if all the data has been received, the process ends.

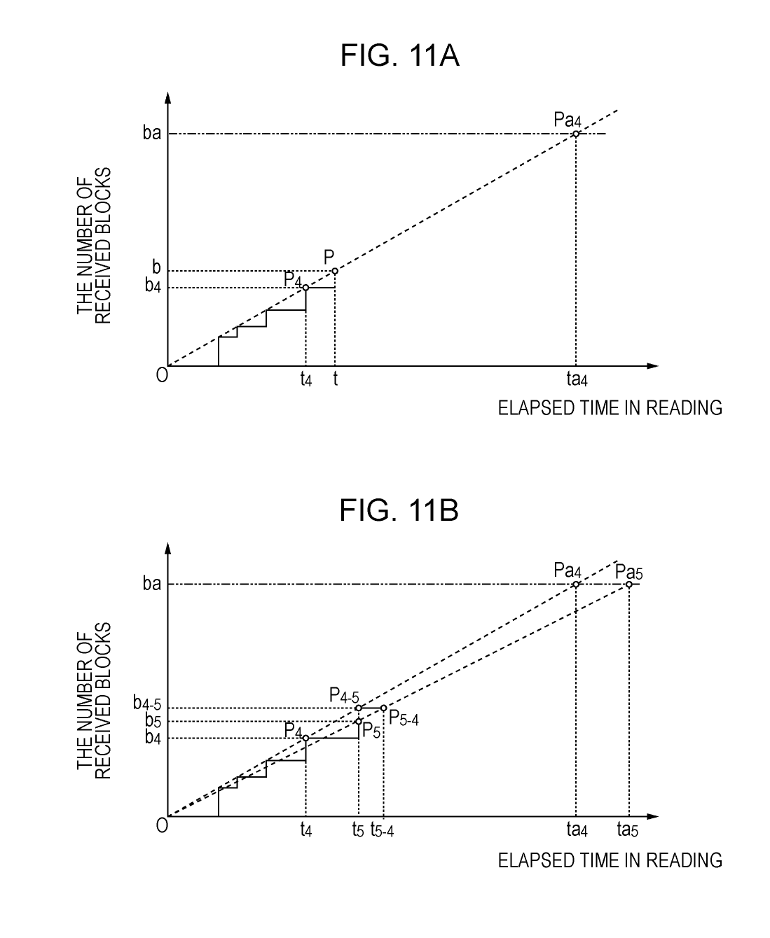

FIG. 11 is a graph for explaining the estimated reading time. The vertical axis is the number of received blocks and the horizontal axis is the elapsed time in reading. A progress state of receiving after the fourth data had been received at time t4 and when the fifth data is being received at time t will be described with reference to FIG. 11A. The total number of blocks calculated from the size of the image is ba, and the cumulative number of blocks that had been received by the time t4 is b4 (point P4). The line O-P4 from the origin O to the point P4 is extended, and the time ta4 (point Pa4) at which the cumulative number of received blocks is ba is determined to be the estimated entire reading time. The estimated progress state of receiving at time t is t/ta4. The number of received blocks b corresponding to the point P at time t on the line O-Pa4 is the estimated cumulative number of received blocks. This estimation is newly started every time 1024 bytes of data, which is a unit amount of information, is received. FIG. 11B shows a case in which the fifth data is received at time t5, and b5 (point P5) which is the cumulative number of blocks received by time t5 is smaller than b4-5 which has been displayed by estimation since the time t4. In this case, display is not changed and the receiving state of b4-5/ba is continuously displayed until the time t5-4 (point P5-4) at which the cumulative number of received blocks, which is estimated from the line extended from the line O-P5, reaches b4-5. Thereafter, a receiving state estimated from the line extended from the line O-P5 is displayed. This is to prevent a user from being confused by the display on which the receiving state goes back.

By the operation described above, in a system in which data is variable-length compressed in a scanner and sequentially transferred to the image processing apparatus, it is possible to show the estimated progress state while image data is being received and show the actual progress state to a user when the image date has been received.

The present invention can also be realized by performing the following processing. Software (program) for realizing the functions of the exemplary embodiments described above is supplied to a system or an apparatus via a network or various storage media, and a computer (or CPU or MPU) of the system or the apparatus reads and executes the program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-292836 filed Dec. 24, 2009, which is hereby incorporated by reference herein in its entirety.

What is claimed is:

1. An image processing system that transmits original image data read by an image reading device to an image processing apparatus, the image processing system comprising:
the image reading device configured to read the original image data according to a reading condition, the image reading device including a reading unit configured to read the original image data, a compression unit configured to perform a variable-length compression operation on the original image data for each block, and a first transmitting unit configured to transmit compressed data compressed by the compression unit to the image processing apparatus for each unit quantity; and
the image processing apparatus including an acquisition unit configured to acquire the size of the original image data, a first calculator configured to obtain the total number of the blocks included in the original image data based on the size of the original image data, a first receiving unit configured to receive the compressed data transmitted by the first transmitting unit, a decompression unit configured to perform a decompression operation on the received data received by the first receiving unit, a second calculator configured to obtain the number of the blocks included in the decompressed image data decompressed by the decompression unit, and a display unit configured to display a progress state of receiving in the first receiving unit from a relationship between the total number of the blocks included in the original image data and the number of received blocks included in the received data that has already been received by the first receiving unit.

2. The image processing system according to claim 1, wherein
the image processing apparatus includes a second transmitting unit configured to transmit the reading condition to the image reading device, and
the image reading device includes a second receiving unit configured to receive the reading condition transmitted from the image processing apparatus.

3. The image processing system according to claim 2, wherein
the acquisition unit of the image processing apparatus acquires the size of the original image data from the reading condition.

4. The image processing system according to claim 1, wherein
the image reading device transmits the size of the original image data to the image processing apparatus via the first transmitting unit, and
the acquisition unit of the image processing apparatus acquires the size of the original image data by receiving the size of the original image data via the second receiving unit.

5. The image processing system according to claim 1, wherein
the image reading device transmits the compressed data transmitted by the first transmitting unit every time the cumulative amount of the compressed data before transmission reaches the unit quantity, and
the image processing apparatus estimates reading time required to receive the total number of the blocks from a proportional relationship between the cumulative number of blocks that have been received, a time required to receive the cumulative number of blocks, and the total number of the blocks included in the original image data, and displays a relationship between an elapsed time from the start of reading and the estimated reading time as the progress state on the display unit.

6. The image processing system according to claim 5, wherein the display unit of the image processing apparatus does not change the display of the progress state while a progress state that is newly estimated each time the unit quantity is received is smaller than the progress state that has been displayed.

7. An image processing method, comprising;
obtaining image data by reading an original according to a reading condition, performing a variable-length compression operation on the image data for each block, and transmitting the variable-length compressed data to the image processing apparatus for each unit quantity by the image reading device; and
receiving the compressed data, decompressing the received compressed data, and displaying a progress state of the receiving by comparing the cumulative number of the blocks included in the decompressed data and the size of the image data obtained from the reading condition by the image processing apparatus.

8. A storage medium for storing an image processing program executable on an image processing apparatus, said image processing program comprising the steps of:
controlling an image reading device to read an image according to a reading condition to obtain image data, to perform a variable-length compression operation on each block of the image data, and to transmit the compressed data to the image processing apparatus; and
receiving the compressed data, decompressing the received compressed data, and displaying a progress state of the receiving by comparing the number of the image blocks included in the decompressed data and the size of the image data obtained from the reading condition.
